(19) United States
(12) Patent Application Publication
(10) Pub. No.: US 2026/0336698 A1
(43) Pub. Date: Oct. 29, 2026

(54) Steering Angle Sensor and Method for Operating a Steering Angle Sensor

(71) Applicant: Robert Bosch GmbH, Stuttgart (DE)

(72) Inventor: Stefan Kuntz, Flein (DE)

(21) Appl. No.: 19/657,392

(22) Filed: Apr. 24, 2026

(30) Foreign Application Priority Data
Apr. 28, 2025 (DE) 10 2025 116 167.4

(51) Int. Cl. B62D 15/02

(52) U.S. Cl. CPC B62D 15/0215

(57) ABSTRACT

A steering angle sensor for a steering system of a vehicle is disclosed. The steering angle sensor has a rotatable primary target and a rotatable secondary target coupled to the primary target via a fixed transmission ratio. At least one subregion of the primary target and at least one subregion of the secondary target are arranged overlapping a coil surface enclosed by a transmitter coil of the steering angle sensor. The subregion of the primary target is arranged overlapping at least one primary receiver coil of the steering angle sensor and the subregion of the secondary target is arranged overlapping at least one secondary receiver coil of the steering angle sensor.

This application claims priority under 35 U.S.C. § 119 to patent application no. DE 10 2025 116 167.4, filed on Apr. 28, 2025 in Germany, the disclosure of which is incorporated herein by reference in its entirety.

The disclosure relates to a steering angle sensor for a steering system of a vehicle and a method for operating a steering angle sensor.

### BACKGROUND

A position sensor may have an inductive measuring principle. An electromagnetic field is emitted via a transmitter coil. A metallic target that can move relative to the coil is arranged in the field. Eddy currents are induced in the target by the electromagnetic field. The eddy currents counteract the field and disturb the electromagnetic field. The disturbed electromagnetic field is measured via at least one receiver coil and evaluated by electronics. Different positions of the target lead to different disturbances of the field. The position of the target can therefore be deduced from the disturbed electromagnetic field.

In the case of an inductive steering angle sensor, the target can be coupled to a steering shaft of the steering mechanism. When the steering shaft is rotated, the target is moved past the electromagnetic field or within the electromagnetic field. An angle position of the steering shaft can be deduced from the disturbed electromagnetic field. The transmitter coil and the at least one receiver coil may extend annularly around the steering shaft. With a single target, the steering angle can be resolved over 360°. For example, multiple revolutions may be detected by counting.

In order to be able to measure an absolute steering angle over a plurality of revolutions of the steering shaft, a gear with a further target can engage in a toothing of the steering shaft. The gear rotates faster or slower than the steering shaft due to a transmission ratio or reduction ratio of the gearing. The gear thus has a different angular position during each of a plurality of revolutions when the steering shaft passes through a particular angular position. The revolutions can be unambiguously distinguished by an evaluation of both angular positions. The further target may be excited via a further transmitter coil, and the disturbed electromagnetic field of the further target may be received via at least one further receiver coil.

DE 10 2022 208 797 describes an inductive sensor arrangement for determining a rotational angle.

### SUMMARY

Against this background, the approach presented herein presents a steering angle sensor for a steering system of a vehicle and a method for operating a steering angle sensor according to the description set forth below. Advantageous further developments and improvements of the approach presented here will also emerge from the description set forth below.

In the approach presented herein, multiple targets are excited by an enlarged common transmitter coil. The transmitter coil has an enlarged enclosed area. A desired field strength in the area of the enlarged enclosed area may be achieved with a reduced number of turns. Fewer turns require less material and manufacturing effort. Electronic components for operating additional transmitter coils can be omitted by reducing the number of transmitter coils. The evaluation electronics for evaluating receiver coils assigned to the respective target can be simplified by the targets excited together with the same excitation signal. Here too, the simplification can eliminate the need for components.

Through the approach presented herein, a steering angle sensor with reduced material requirements, simplified electronics, and/or reduced space requirements may be provided cost-effectively.

According to a first aspect of the disclosure, a steering angle sensor for a steering system of a vehicle is presented, wherein the steering angle sensor has a rotatable primary target and a rotatable secondary target coupled to the primary target via a fixed transmission ratio, wherein at least one subregion of the primary target and at least one subregion of the secondary target are arranged overlapping a coil surface enclosed by a transmitter coil of the steering angle sensor, wherein the subregion of the primary target is arranged overlapping at least one primary receiver coil of the steering angle sensor and the subregion of the secondary target is arranged overlapping at least one secondary receiver coil of the steering angle sensor.

According to a second aspect of the disclosure, a method for operating a steering angle sensor, in particular a steering angle sensor according to an embodiment of the first aspect of the disclosure, is presented, wherein an excitation signal is fed into a transmitter coil overlapping at least one subregion of a primary target of the steering angle sensor and at least one subregion of a secondary target of the steering angle sensor, wherein at least one primary receive signal is received using a primary receiver coil overlapping at least the subregion of the primary target, and at least one secondary receive signal is received using a secondary receiver coil overlapping at least the subregion of the secondary target, wherein the primary receive signal and the secondary receive signal are evaluated using the excitation signal in order to determine an absolute steering angle.

Ideas concerning embodiments of the present disclosure may be regarded as being based, among other things, on the thoughts and findings described below.

A steering angle sensor can be part of a steering mechanism of a vehicle. The steering angle sensor may absolutely or unambiguously detect an angular position of a rotatable part of the steering system over a plurality of revolutions of the part. The unambiguous angular position may be referred to as an absolute steering angle.

Eddy currents can be induced in a target by an alternating electromagnetic field. The alternating electromagnetic field may be emitted by a transmitter coil through which an alternating current flows. The alternating current may be referred to as the excitation signal. The eddy currents are induced only where the target is formed as a metallic surface. Between the metallic surfaces, the target may comprise electrically nonconductive surfaces. No eddy currents can be induced in the nonconductive surfaces. The metallic and the nonconductive surfaces may be arranged alternately. The surfaces may be arranged regularly or irregularly.

The eddy currents themselves also generate an alternating electromagnetic field that counteracts the original alternating electromagnetic field. The alternating electromagnetic fields thus affect or interfere with each other. A resulting disturbed alternating electromagnetic field may be represented in a receive signal via at least one receiver coil.

Since the target is not electrically conductive everywhere and eddy currents cannot be induced everywhere, the alternating electromagnetic field is also not disturbed equally everywhere, but represents a position or orientation of the target. When the target is moved in the alternating electromagnetic field, the alternating electromagnetic field changes and thus also the receive signal. For example, an association between a change in position of the target and a change in the receive signal may be pre-defined or detected and stored upon reference of the steering angle sensor.

In the approach presented herein, two targets are excited using the same transmitter coil, but evaluated using signals from different receive coils. The two targets may be referred to as a primary target and a secondary target. The targets can be excited completely, i.e., in full, or only partially, i.e., only in subregions. The transmitter coil can extend around the targets or around the subregions. The receiver coils can each be arranged in the area of the targets or in the area of the subregions. The receiver coils may be referred to as a primary receiver coil and a secondary receiver coil. A surface enclosed by the transmitter coil may be referred to as a coil surface. The coil surface may comprise two subregions. The subregions can substantially correspond to the targets or the subregions of the targets. The subregions may be connected. The subregions may be referred to as a primary subregion and a secondary subregion.

The steering angle sensor may include a mechanism configured to operate the transmitter coil and to evaluate the received signals of the receiver coils.

The transmitter coil may comprise a primary loop encompassing at least the subregion of the primary target and a secondary loop encompassing at least the subregion of the secondary target. A direction of traversal of the secondary loop may be opposite a direction of traversal of the primary loop. The primary loop may completely enclose the primary subregion. The secondary loop may completely enclose the secondary subregion. The primary subregion and the secondary subregion may thereby be non-contiguous. The traces comprising the transmitter coil may be crossed between the primary subregion and the secondary subregion. To this end, for example, the traces may be arranged in different planes of a printed circuit board. The layer changes can be produced using vias. The alternating electromagnetic field can be formed particularly homogeneously by the complete enclosure with no gap.

The primary target may annularly encircle a steering shaft. The primary target may be connected to the steering shaft in a rotationally fixed manner. The steering shaft may be arranged in an interior space of the primary target. By arranging the steering shaft in the interior space, the steering angle sensor may require little space.

The transmitter coil may be configured as at least one trace of a printed circuit board of the steering angle sensor arranged parallel to the primary target and the secondary target. In particular, the transmitter coil can consist of two substantially parallel traces. For example, the transmitter coil may be manufactured by etching or printing on the printed circuit board. The printed circuit board may have a small distance from the targets. The distance may be the same to the primary target and secondary target.

The primary receiver coil and the secondary receiver coil may be arranged within the coil surface. The receiver coils may also be configured as traces of the printed circuit board. The primary receiver coil and/or the secondary receiver coil may be configured as sinusoidal traces. The primary receiver coil and the secondary receiver coil may be annular or curved. The primary receiver coil may be arranged concentrically with a pivot point of the primary target. The secondary receiver coil may be arranged concentrically with a pivot point of the secondary target.

An air gap between the secondary target and the transmitter coil and/or the secondary receiver coil may be less than an air gap between the primary target and the transmitter coil and/or the secondary receiver coil. The primary target and the secondary target may be arranged in different planes. By using different air gaps, a difference in signal strength induced by the differently sized targets can be at least proportionally compensated. A smaller target induces less signal. This can be counteracted by the smaller air gap. Due to the larger air gap of the larger target, larger manufacturing and assembly tolerances can be accepted, e.g., bent wings of the target do not directly lead to a collision with the printed circuit board. The primary target and the secondary target may be arranged adjacent to each other without overlap.

The coil surface may completely overlap the primary target and/or the secondary target. At least one of the targets may be arranged entirely within the coil surface. A maximum possible angular resolution of the steering angle sensor can be achieved by a full overlap.

The excitation signal may be fed in using a resonant circuit comprising the transmitter coil. The resonant circuit may be a simple L-C resonant circuit and may have a fixed oscillation frequency. The resonant circuit may also be tunable. By using the single transmitter coil to excite the two targets, an entire resonant circuit can be dispensed with.

The oscillation frequency of the resonant circuit may be used to demodulate the primary reception signal and the secondary reception signal. Since both receive signals are directly dependent on the same excitation signal, the oscillation frequency may simply be removed from the receive signals.

### BRIEF DESCRIPTION OF THE DRAWINGS

Embodiments of the disclosure are described in the following with reference to the accompanying drawings, wherein neither the drawings nor the description are to be construed as limiting the disclosure.

FIG. 1 shows an illustration of a steering angle sensor according to an exemplary embodiment.

FIG. 2 shows an illustration of a steering angle sensor according to an exemplary embodiment.

FIG. 3 shows an illustration of a steering angle sensor according to an exemplary embodiment.

The figures are merely schematic and are not to scale. Identical reference numerals denote identical or functionally identical features.

### DETAILED DESCRIPTION

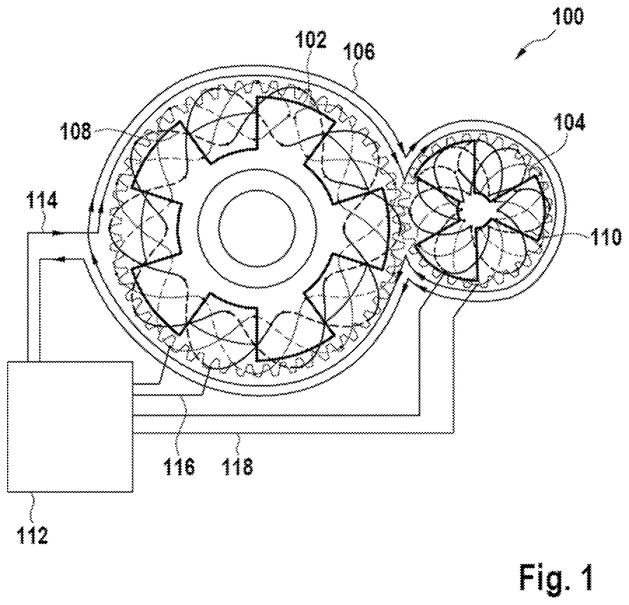

FIG. 1 shows an illustration of a steering angle sensor 100 according to an exemplary embodiment. The steering angle sensor 100 is configured to unambiguously detect a steering angle of a steering system over a plurality of revolutions. To do so, the steering angle sensor 100 has a primary target 102 and a secondary target 104. The primary target 102 and the secondary target 104 are arranged on meshing gears. The gears have different numbers of teeth. The gear of the primary target 102 here has 52 teeth. The gear of the secondary target 104 here has 28 teeth and is smaller than the gear of the primary target 102. The primary target 102 and the secondary target 104 are arranged on the gears and each have a sequence of metallic surfaces and gaps along a circumference of the gears. Here, the primary target 102 has five surfaces and five gaps. Here, the secondary target 104 has three surfaces and three gaps. The surfaces of the primary target 102 are joined to each other by an internal metallic ring. The secondary target 104 has a central metallic surface that connects the surfaces to each other.

Further, the steering angle sensor 100 has a common transmitter coil 106 for the primary target 102 and the secondary target 104, two primary receiver coils 108 for the primary target 102, two secondary receiver coils 110 for the secondary target, and an operating facility 112.

The transmitter coil 106 comprises two parallel windings here. The windings run along the circumferences of the gears to a meshing region in which the gears engage each other. Prior to the meshing region, the windings each have a sharp bend and run from there along the respective other gear. There are no windings of the transmitter coil 106 above the meshing region. As a result, the primary target 102 and the secondary target 104 are completely overlapped here by a coil surface enclosed by the transmitter coil. Alternatively, only subregions of the primary target 102 and/or the secondary target 104 may be overlapped by the coil surface.

The primary receiver coils 108 and the secondary receiver coils 110 are arranged within the coil surface. The primary receiver coils 108 and the secondary receiver coils 110 are undulating and thus overlap an annular area of the primary target 102 and the secondary target 104, respectively. The annular region overlaps each of the metallic surfaces and the gaps between those surfaces of the respective targets. For both targets, the two coils each have an offset in the circumferential direction. In particular, the waves are sinusoidal, and the coils have an offset of a quarter wavelength.

In an exemplary embodiment, the two receiver coils each have two turns. The turns have an offset relative to each other of half a wavelength.

The operating facility 112 is electrically conductively connected to all coils 106, 108, 110. The operating facility 112 outputs an excitation signal 114 via the transmitter coil 106. The excitation signal 114 is an AC signal and generates an alternating electromagnetic field in the coil surface 116 enclosed by the transmitter coil 106.

The alternating field induces eddy currents in the primary target 102 and secondary target 104. The eddy currents generate an alternating field opposite to the alternating field and thus interfere with it. The disturbed alternating field couples into the receiver coils, and the operating facility 112 reads in one receive signal per receiver coil. Thus, two primary receive signals 116 are read in from the two primary receiver coils 108, and two secondary receive signals 118 are read in from the secondary receiver coils 110.

The operating device 112 evaluates the receive signals 116, 118 using the excitation signal 114.

In other words, FIG. 1 shows the entire sensor system with an inductive IC, a transmitter coil (with a representation of the winding direction), two receiver coil systems, a first gear connected to a shaft (hub), a second gear connected to the first gear, and two targets each connected to a gear.

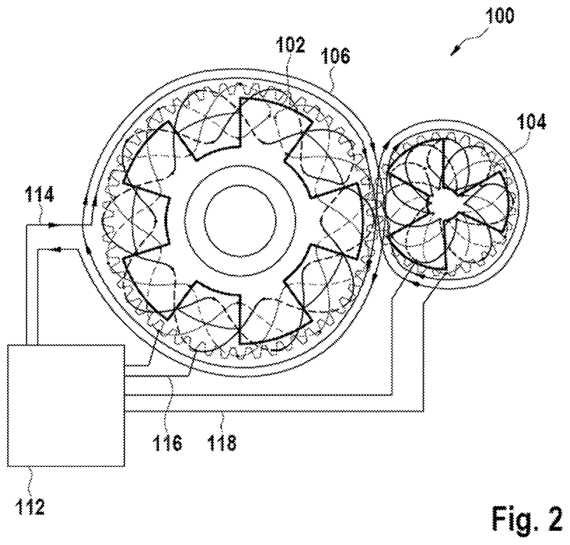

FIG. 2 shows an illustration of a steering angle sensor 100 according to an exemplary embodiment. The steering angle sensor 100 essentially corresponds to the steering angle sensor in FIG. 1. In contrast, the windings of the transmitter coil 106 cross over above the meshing region. Thus, the direction of traversal of the excitation signal in the area of the secondary target 104 is opposite to the direction of traversal in the area of the primary target 102.

In other words, FIG. 2 shows a further embodiment with a modified transmitter coil. Here, the traces of the transmitter coil cross using vias (not shown) on different layers of the printed circuit board to prevent a short circuit, so that the receiver coils are now completely enclosed. In this case, the direction of traversal of the sections of the transmitter coil associated with the receiver coil systems is opposite.

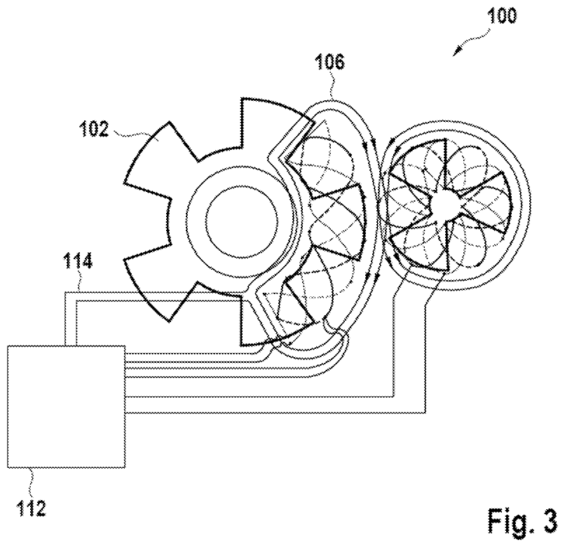

FIG. 3 shows an illustration of a steering angle sensor 100 according to a further exemplary embodiment. The steering angle sensor 100 essentially corresponds to the steering angle sensor in FIG. 2. In contrast to this, the coil surface enclosed by the transmitter coil 106 here overlaps only a subregion of the primary target 102. Here, only an area is overlapped that corresponds to two metallic areas and a gap between them.

Possible embodiments of the disclosure are summarized again below or presented with a slightly different choice of words.

An inductive steering angle sensor with a satellite gear is presented.

A steering angle sensor with true power-on detection of the absolute steering angle may use at least two angle measurements, which are processed into a mechanical absolute angle using the vernier principle. Known are, for example, magnetic principles with a shaft gear and two satellite gears or, for example, inductive systems with a planetary gear train (DE 10 2022 208 797).

Here, a cost-effective steering angle sensor with only one inductive integrated circuit (per redundant channel) is presented, in which the mechanical complexity is reduced as much as possible in order to reduce the cost of the sensor and still ensure good signal quality (e.g., against interfering fields).

The presented steering angle sensor uses only two gears on which inductive targets are mounted in order to keep the mechanical complexity and costs low. In addition, a single common inductive integrated circuit is used per output signal channel, which evaluates the two coil systems associated with the targets. A single transmitter coil is used for both coil systems, which greatly simplifies demodulation in the IC and also saves pins on the IC package, further reducing costs.

The transmitter coil is designed to completely or nearly completely enclose the two receiver coil systems despite shared use in order to achieve the best possible signal quality.

A gear can thus be dispensed with compared to magnetic steering angle sensors or inductive steering angle sensors with planetary gear trains. In addition, the arrangement of the gears still offers the possibility of passing a shaft through the gear without impairing the inductive measurement. The application is therefore not limited to end-of-shaft sensors.

The sensor system consists of gears, inductive targets, coil systems, and an IC.

The illustrated arrangement of gears with 52 and 28 teeth, coupled with targets with a periodicity of p1=5 and p2=3, provides a true power-on unambiguous range of the absolute steering angle of ±1260 degrees (in both directions), with good angular robustness of the vernier of approximately 5 electrical degrees.

A major advantage is arranging the first target of the gear connected to the shaft within the outer diameter of the first gear in order to avoid overlap of the receiver coil systems on the printed circuit board. However, the first target can be made with a large bore to enable the shaft (hub) to pass through. For the second target, this is usually not necessary due to the lack of a shaft. Nevertheless, a recess in the target can be provided here to enable a bearing of the gear, which keeps the air gap between the second target and the printed circuit board as small as possible in order to obtain a good amplitude of the induced voltage.

Preferably, the periodicity (number of wings) of the first target is greater than or equal to the periodicity of the second target in order to achieve better accuracy of the angle measurement.

Lastly, it should be noted that terms such as “comprising”, “including”, etc. do not exclude other elements or steps and terms such as “one” or “a” do not exclude a plurality.

What is claimed is:

1. A steering angle sensor for a steering system of a vehicle, comprising:
a transmitter coil;
at least one primary receiver coil;
at least one secondary receiver coil;
a rotatable primary target; and
a rotatable secondary target coupled to the primary target via a fixed transmission ratio,
wherein at least one subregion of the primary target and at least one subregion of the secondary target are arranged overlapping a coil surface enclosed by the transmitter coil, and
wherein the subregion of the primary target is arranged overlapping the at least one primary receiver coil and the subregion of the secondary target is arranged overlapping the at least one secondary receiver coil.

2. The steering angle sensor according to claim 1, wherein:
the transmitter coil includes a primary loop enclosing at least the subregion of the primary target and a secondary loop enclosing at least the subregion of the secondary target, and
a direction of traversal of the secondary loop is opposite a direction of traversal of the primary loop.

3. The steering angle sensor according to claim 1, wherein:
the primary target annularly encloses a steering shaft of the steering system, and
the primary target is connected to the steering shaft in a rotationally fixed manner.

4. The steering angle sensor according to claim 1, wherein the transmitter coil is formed as at least one trace of a printed circuit board of the steering angle sensor arranged parallel to the primary target and the secondary target.

5. The steering angle sensor according to claim 1, wherein the primary receiver coil and the secondary receiver coil are arranged within the coil surface.

6. The steering angle sensor according to claim 1, wherein an air gap between the secondary target and the transmitter coil and/or the secondary receiver coil is less than an air gap between the primary target and the transmitter coil and/or the secondary receiver coil.

7. The steering angle sensor according to claim 1, wherein the coil surface completely overlaps the primary target and/or the secondary target.

8. A method for operating a steering angle sensor, comprising:
feeding an excitation signal into a transmitter coil overlapping at least one subregion of a primary target of the steering angle sensor and at least one subregion of a secondary target of the steering angle sensor;
receiving at least one primary receive signal using a primary receiver coil overlapping the at least the subregion of the primary target, and receiving at least one secondary receive signal using a secondary receiver coil overlapping the at least the subregion of the secondary target; and
evaluating the primary receive signal and the secondary receive signal using the excitation signal in order to determine an absolute steering angle.

9. The method according to claim 8, further comprising supplying the excitation signal using a resonant circuit comprising the transmit coil.

10. The method according to claim 9, further comprising using an oscillating frequency of the resonant circuit to demodulate the primary receive signal and the secondary receive signal.
